(19) United States
(12) Patent Application Publication
(10) Pub. No.: US 2010/0143530 A1
(43) Pub. Date: Jun. 10, 2010

(54) EXTRUDER WITH MEANS FOR ADJUSTING A WIDTH OF EXTRUDED OBJECT

(75) Inventors: Myung Chul Park, Daejeon (KR); Hee June Kim, Daejeon (KR)

Correspondence Address: CANTOR COLBURN, LLP, 20 Church Street, 22nd Floor, Hartford, CT, 06103, US

(73) Assignee: LG CHEM, LTD., Seoul (KR)

(21) Appl. No.: 12/524,042

(22) PCT Filed: Oct. 5, 2007
(86) PCT No.: PCT/KR2007/004866

§ 371 Date: Sep. 15, 2009

(30) Foreign Application Priority Data
Jan. 22, 2007 (KR) 10-2007-0006607

(51) Int. Cl. B29C 47/16

(52) U.S. Cl. 425/466

(57) ABSTRACT

The present invention discloses an extruder capable of adjusting in real time a width of a sheet-shaped extruded object discharging from a T-die. The extruder according to the present invention comprises an extruding unit in which raw material is mixed and extruded; a T-die forming an extruded object supplied from the extruding unit into a sheet shaped extruded object; and a first width-adjusting means provided at one side of a front portion of the T-die to adjust a width of the sheet-shaped extruded object discharged from the T-die in real time. The extruder according to the present invention can further comprise a second width-adjusting means for the extruded object. The second width-adjusting means comprise the members which are the same as those constituting the first width-adjusting means, and is disposed at the other side of a front portion of the T-die and symmetrical to the first width-adjusting means.

### TECHNICAL FIELD

The present invention relates to an extruder, more particularly, to an extruder which can adjust a width of an extruded object in real time through a width-adjusting means for an extruded object, provided at a discharge port of a T-tie.

### BACKGROUND ART

In general, an extruder is an apparatus for extruding synthetic resin material to produce an article having a designed shape. The extruder can be classified into a screw-type extruder utilizing a screw and a non-screw type extruder in which a screw is not adopted.

Examples of the non-screw type extruder include elastic melt extruders, hydro-dynamic extruders, ram-type continuous extruders, gear-type extruders and the like. The elastic melt extruders are the extruders in which an extruding is performed by utilizing a normal stress effect of viscoelastic material, the hydro-dynamic extruders are extruder utilizing a fluid principle of Kingsbury type or Michell type thrust bearing. In addition, the ram-type continuous extruder is the extruder consisting of a combination of two ram-type preliminary plastic extruders disposed oppositely and both extruding ram and barrel.

In the meantime, the screw-type extruder is the extruder utilizing a principle of a gear pump for conveying oil. In the screw-extruder, three double-helical gears are disposed perpendicularly to feed raw material from an upside and convey downward raw material.

As compared with the non-screw type extruder as described above, the screw-type extruder utilizing is advantageous in that a conveying stability of raw material is high and a time for which raw material is stayed is sufficient. In recent, accordingly, the screw-type extruder mentioned above has been widely used.

Below, the screw type extruder mentioned above is illustrated with reference to FIG. 1.

FIG. 1 is a view illustrating schematically an inner structure of an extruding unit constituting a screw-type extruder, an extruding unit 10 comprises a barrel 11, a rotational shaft 12 provided rotatably in the barrel 11 and a screw 13 mounted to an outer circumference surface of the rotational shaft 12.

The rotational shaft 12 is rotated by a driving means M such as a motor. On the other hand, the barrel 11 acting as an external housing is provided with a plurality of hoppers 14 and 15, and so raw material or reinforced fiber is introduced into the barrel 11 through the hoppers 14 and 15.

An extruded object mixed and extruded through the extruding unit having the above structure is supplied to a T-die, a shape of the extruded object is modified into the designed sheet shape while the extruded object passes through the T-die.

FIG. 2 is a schematic view of a T-die constituting the conventional extruder, a T-die 20 connected to the extruding unit 10 shown in FIG. 1 comprises an upper block 21 and a lower block 22 disposed at a certain interval.

At rear end portions of the upper block 21 and the lower block 22, an inlet port 23 communicated in fluid to a discharge port 16 of the extruding unit 10 shown in FIG. 1 is formed. Accordingly, the extruded object extruded in the extruding unit 10 is introduced into a space between the upper block 21 and the lower block 22 through the inlet port 23.

The extruded object 30 passing through the space between the upper block 21 and the lower block 22 has a sheet shape with a thickness that is the same as a distance between the upper block 21 and the lower block 22.

At this time, to change a thickness of the sheet-shaped extruded object discharged from the T-die 20, a distance between the upper block 21 and the lower block 22 and a width of discharging area of the T-die 20 should be adjusted to a predetermined value before performing an extruding process.

In addition, to change a thickness of the extruded object during an extruding process, a structure consisting of a tightening member 24 and a tightening member supporter 25 is formed on a lower portion of the lower block 22 as shown in FIG. 2. In the above structure, the lower block 22 can be moved with respect to the upper block 21 by tightening or loosening the tightening member 24 to adjust a distance between the upper block 21 and the lower block 22, and so it is possible to adjust a thickness of the sheet-shaped extruded object 30 in the extruding process.

FIG. 3 is a perspective view of the extruded object 30 discharged from the T-die shown in FIG. 2 and shows that a thickness of the extruded object 30 is adjusted by a changing a location of the lower block 22 so that the extruded object 30 has uneven thickness t1 or t2, that is, a thickness of a portion of the extruded object partially differs from that of other portion.

It is possible to adjust a thickness of the extruded object 30 discharged from the T-die 20 in real time to produce the extruded objects having various thickness. However, the extruder as described above has the problem that a width of the extruded object can not adjusted so that the extruded objects having various profiles can not be manufactured.

### DISCLOSURE OF INVENTION

### Technical Problem

An object of the present invention is to provide an extruder capable of adjusting a width of a sheet-shaped extruded object discharged through a T-die in real time.

### Technical Solution

In order to achieve the above object, an extruder according to the present invention comprises an extruding unit in which raw material is mixed and extruded; a T-die forming an extruded object supplied from the extruding unit into a sheet shaped extruded object; and a first width-adjusting means provided at one side of a front portion of the T-die to adjust a width of the sheet-shaped extruded object discharged from the T-die in real time.

The width-adjusting means comprises a driving unit and an actuator which is connected to an operating rod of the driving unit and can be rotated about a central portion thereof to allow an end portion of the rotated actuator to pressurize a side edge of the sheet-shaped extruded object discharged from the T-die.

Here, the width-adjusting means and the T-die are mounted on a base, and the actuator is the member having a certain length and a hole formed at a central portion thereof for receiving a shaft fixed to the base to allow the actuator to rotate about the shaft when the driving unit is operated.

On the contrary, the width-adjusting means can be mounted to a bracket secured to the T-die, and the actuator is the member having a certain length and a hole formed at a central portion thereof for receiving a shaft fixed to the bracket to allow the actuator to rotate about the shaft when the driving unit is operated.

On the other hand, the extruder according to the present invention can further comprise a second width-adjusting means for the extruded object. The second width-adjusting means comprise the members which are the same as those constituting the first width-adjusting means, and is disposed at the other side of a front portion of the T-die and symmetrical to the first width-adjusting means.

### ADVANTAGEOUS EFFECTS

The present invention has an advantage that a width of a sheet-shaped extruded object discharged from a T-die can be adjusted in real time to obtain the extruded object having various dimensions (widths).

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a view illustrating a structure of an extruding unit constituting a conventional extruder;

FIG. 2 is a schematic view of a T-die constituting a conventional extruder;

FIG. 3 is a perspective view of an extruded object discharged from a T-die shown in FIG. 2;

FIG. 4 is an exploded perspective view illustrating a relation between a width-adjusting means for an extruded object and a T-die constituting an extruder according to one embodiment of the present invention;

FIG. 5 is a perspective view of an extruded object manufactured through an extruder comprising a width-adjusting means for an extruded object and a T-die shown in FIG. 4; and

FIG. 6 is an exploded perspective view illustrating a relation between a width-adjusting means for an extruded object and a T-die constituting an extruder according to another embodiment of the present invention.

### BEST MODE FOR CARRYING OUT THE INVENTION

Hereinafter, an extruder according to the embodiment of the present invention will be described in more detail with reference to accompanying drawings.

An extruder according to the present invention comprises an extruding unit for mixing raw material (synthetic resin) and extruding the mixed raw material and a T-die unit for modifying a shape of an extruded object discharged from the extruding unit into a designed sheet shape.

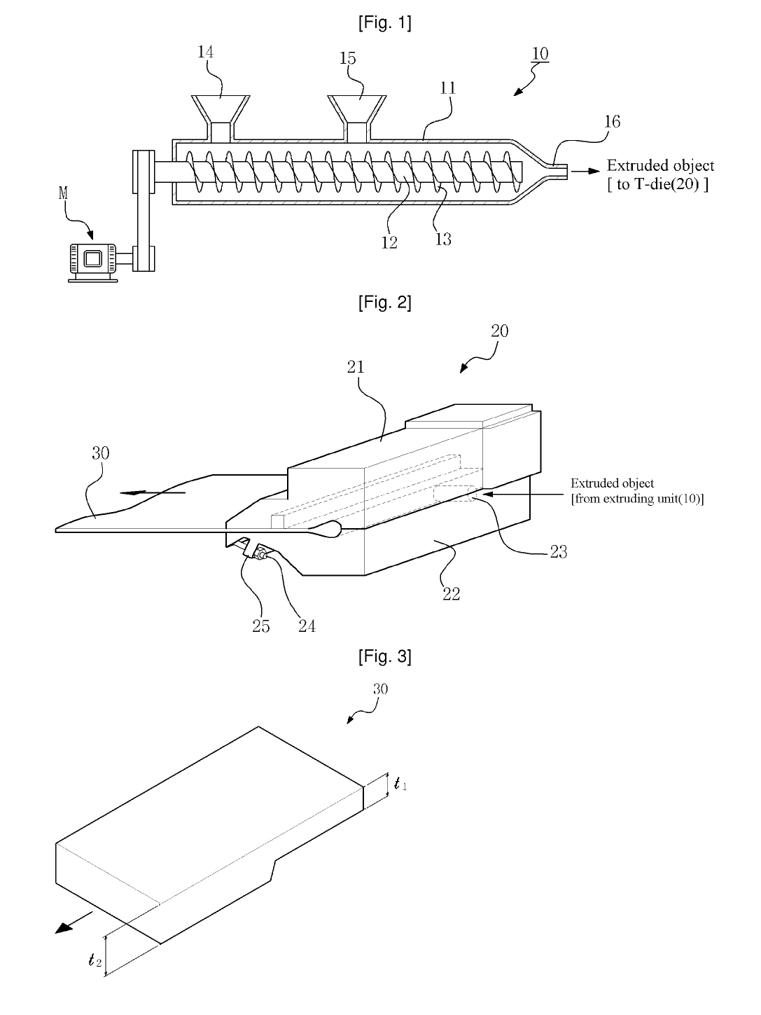

A structure and function of the extruding unit constituting the extruder according to the present invention are the same as those of the extruding unit of the extruder shown in FIG. 1, and so a detail description thereof is omitted.

Major feature of the extruder according to the present invention is to mount a width-adjusting means capable of adjusting a width of sheet-shaped extruded object in real time, on a place adjacent to a discharge port through which the sheet shaped extruded object.

Below, a structure and function of the width-adjusting means for the extruded object are described in detail.

### First Embodiment

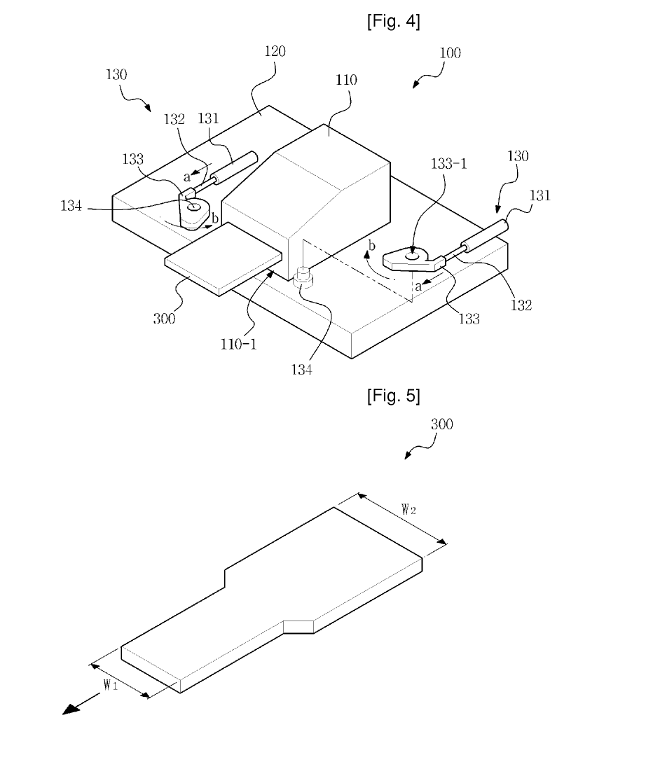

FIG. 4 is a schematic perspective view of a T-die unit constituting an extruder according to the first embodiment of the present invention, a T-die unit 100 comprises a base 120, a T-die 110 installed on the base 120 and modifying a shape of extruded object discharged from the extruding unit (10 in FIG. 1) into a designed sheet shape, and first and second width-adjusting means 130 provided at both sides of the T-die 100, respectively, for adjusting a width of the extruded object.

An inlet port (not shown) into which an extruded object discharged from the extruding unit is introduced is formed at a rear portion of the T-die 110, and a discharge port 110-1 from which the sheet-shaped extruded object is discharged is formed at a front portion of the T-die. An inner structure and a function of the T-die 110 are the same as those of the conventional T-die, and so a detail description thereof is omitted.

The first and second width-adjusting means 130 correspond to both sides of a front portion of the T-die 110. On the other hand, although FIG. 4 shows that two width-adjusting means 130 are provided, it will undoubtedly be possible to install one width-adjusting means 130 at only one side of a front portion of the T-die 110.

The first width-adjusting means has the structure which is symmetrical to that of the second width-adjusting means about the T-die 110. Here, FIG. 4 shows that the left width-adjusting means is mounted to the base 120 and the right width-adjusting means is detached from the base 120.

Below, one of two width-adjusting means 130 is described as an example.

The width-adjusting means 130 comprises a driving unit 131 mounted on the base 120 and an actuator 133 provided rotatably about a shaft 134 secured to the base 120.

Preferably, pneumatic cylinder, hydraulic cylinder or servo motor can be utilized as the driving unit 131, and an operating rod 132 of the driving unit 131 is connected to the actuator 133. On the other hand, the shaft 134 corresponds to a front end portion of the T-die 110, that is, the shaft is provided at a place of the base 120 adjacent to the discharge port 110-1.

The actuator 133 is the member having a certain length and a hole 133-1 formed at a center portion thereof for receiving the shaft 134 secured to the base 120. On the other hand, a front portion of the actuator 133 corresponds to a front end portion of the T-die 110, and a rear portion is connected to a front end of the operating rod 132 of the driving unit 131. Accordingly, by a linear movement of the operating rod 132 caused by an operation of the driving unit 131, the actuator 133 is rotated about the shaft 134 received in the hole.

A function of the width-adjusting means 130 for the extruded object constructed as described above is illustrated with reference to FIG. 4.

The extruded object discharged from the extruding unit (10 in FIG. 1) is introduced into the T-die 110 through the inlet port, the extruded object in the shape of the sheet having a certain width is then discharged through the discharge port 110-1 formed at a front end portion of the T-die 110.

In a process of discharging the sheet-shaped extruded object 300, where there is need to adjust a width of the extruded object, the driving unit 131 is operated to move forward the operating rod 132 (in the arrow a direction in FIG. 4). As the operating rod 132 is moved forward, the actuator 133 is rotated (in the arrow b direction in FIG. 4.) about the shaft 134 placed at a central portion thereof. Accordingly, a front end portion of the actuator 133 becomes correspond to and pressurize a side edge of the sheet-shaped extruded object 300 discharged through the discharge port 110-1 of the T-die 110 with a certain pressure.

Rotations of the actuators 133 as described above are simultaneously generated in two width-adjusting means 130 for the extruded object provided at both sides of the T-die 110. Accordingly, a width of the extruded object 300 is decreased in proportion to a rotational angle of the actuator 133.

On the other hand, a temperature of the sheet-shaped extruded object 300 discharged from the extruding unit and the T-die 100 is relatively high. On the contrary, the actuator 133 becomes in contact with the extruded object 300 has relative low temperature. Therefore, there is a concern that a shape of the extruded object 300 can be transformed due to a large temperature difference between the extruded object 300 and the actuator 133.

To prevent a transformation of a shape of the extruded object 300 caused by the above the temperature difference, it is preferable to mount a heating means (not shown), for example, electric heating wire, in the actuator 133 to reduce a temperature difference between the extruded object 300 and the actuator 133.

FIG. 5 is a perspective view of the extruded object manufactured through the extruder comprising the width-adjusting means for the extruded object and the T-die shown in FIG. 4.

The actuators 133 which was rotated pressurize both side edges of the hot extruded object 300, which is discharged through the discharge port 110-1 formed at a front end of the T-die 110, in a widthwise direction. As shown in FIG. 5, accordingly, as compared a width W2 of the extruded object 300 obtained before the actuators 133 are rotated, a width W1 of the extruded object 300 obtained after the actuators 133 are rotated is reduced, and so the extruded object 300 has a width which is partially different.

On the other hand, when the extruded object 300 is discharged through the discharge port 110-1 formed at a front end of the T-die 110, if the driving units 131 are halted and rotations of the actuators 133 are ceased, the sheet-shaped extruded object 300 with a predetermined constant width (for example, W2) can be continuously discharged.

### Second Embodiment

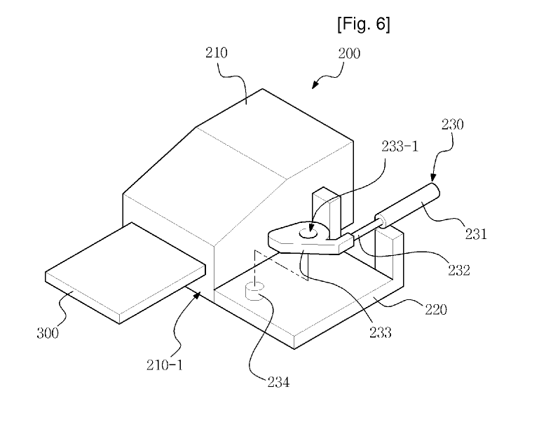

FIG. 6 is an exploded perspective view illustrating a relation between a width-adjusting means for an extruded object and a T-die constituting an extruder according to another embodiment of the present invention.

A T-die unit 200 constituting an extruder according to the present embodiment comprises a T-die 210 modifying a shape of an extruded object discharged through the extruding unit (10 in FIG. 1) into a designed sheet shape, a bracket 220 secured to the T-die 210 and a means 230 mounted on the bracket 220 for adjusting a width of the extruded object.

A structure and function of the T-die 210 are the same as those of the T-die 110 shown in FIG. 4, and so the detailed description thereon is omitted.

The width-adjusting means 230 for the extruded object is provided at one side of a front portion of the T-die 210. In the meantime, although FIG. 6 shows that one width-adjusting means 230 for the extruded object is provided, two brackets 220 can be secured to both sides of the T-die 210 and two width-adjusting means 230 can be mounted to the brackets, respectively to allow each of the width-adjusting means to be corresponded to a side of a front portion of the T-die 210.

The width-adjusting means 230 comprises a driving unit 231 mounted on the bracket 220 and an actuator 233 provided rotatably about a shaft 234 secured to the bracket 220.

Functions of the driving unit 231 and the actuator 233 are the same as those of the driving unit 131 and the actuator 133 of the first embodiment described previously, and so a detail description thereof is omitted.

An overall operation of the extruder according to this embodiment and a shape of the extruded object 300 produced through the extruder according to this embodiment are the same as an overall operation of the extruder according to the first embodiment and a shape of the extruded object produced through the according to the first embodiment, and so a detail description thereon is omitted.

In the extruder according to the present invention, on the other hand, two actuators can be operated under the same condition to produce the extruded object having the symmetrical shape and only one actuator can be operated to produce the non-symmetrical shaped extruded object. That is, the non-symmetrical shaped extruded object can be manufactured by controlling separately the driving units 131 and 231 by which the actuators 133 and 233 are rotated.

In addition, the operator can input the data related to a shape of the designed extruded object 300 into a computer to allow the computer to control selectively the driving units 131 and 231 on the basis of the inputted data, and so a shape of the extruded object can be modified in real time. Consequently, the extruded objects having various shapes can be manufactured by means of the extruder according to the present invention.

As the material used for manufacturing the sheet-shaped extruded object having various dimensions through the extruder according to the present invention, reinforced plastic material may used. Preferably, reinforced plastic material obtained by mixing organic or inorganic fiber reinforced material and polymer material selected from the group consisting of polyethylene, polypropylene, polybutylene terephthalate, polyethylene terephthalate, polyamide, acrylonitrile butadiene styrene resin, poly-carbonate/acrylonitrile butadiene styrene and the like may be used. At this time, for the fiber reinforced material, any one of glass fiber and carbon fiber may be used.

The scope of the present invention is not limited to the embodiments described above and the scope of the present invention is determined and defined only by the appended claims. Further, those skilled in the art can make various changes and modifications thereto without departing from its true spirit. Therefore, various changes and modifications obvious to those skilled in the art will fall within the scope of the present invention.

### INDUSTRIAL APPLICABILITY

The extruder according to the present invention is applicable to the industrial field for manufacturing the sheet-shaped extruded object with a width which is partially different.

1. An extruder, comprising;
an extruding unit in which raw material is mixed and extruded;
a T-die forming an extruded object supplied from the extruding unit into a sheet shaped extruded object; and
a first width-adjusting means provided at one side of a front portion of the T-die to adjust a width of the sheet-shaped extruded object discharged from the T-die in real time.

2. The extruder according to claim 1, wherein the width-adjusting means comprises a driving unit and an actuator which is connected to an operating rod of the driving unit and can be rotated about a central portion thereof to allow an end portion of the rotated actuator to pressurize a side edge of the sheet-shaped extruded object discharged from the T-die.

3. The extruder according to claim 2, wherein the width-adjusting means and the T-die are mounted on a base, and the actuator is the member having a certain length and a hole formed at a central portion thereof for receiving a shaft fixed to the base to allow the actuator to rotate about the shaft when the driving unit is operated.

4. The extruder according to claim 2, wherein the width-adjusting means is mounted to a bracket secured to the T-die, and the actuator is the member having a certain length and a hole formed at a central portion thereof for receiving a shaft fixed to the bracket to allow the actuator to rotate about the shaft when the driving unit is operated.

5. The extruder according to claim 1, wherein the actuator comprises an electrical heating wire provided therein and connected to a source of electricity.

6. The extruder according to claim 1, further comprising a second width-adjusting means for the extruded object, the second width-adjusting means comprising the members which are the same as those constituting the first width-adjusting means, disposed at the other side of a front portion of the T-die and being symmetrical to the first width-adjusting means

7. The extruder according to claim 1, wherein the raw material of the extruded object is a mixture of organic or inorganic fiber-reinforced material and one or more polymer material selected from the group consisting of polyethylene, polypropylene, polybutylene terephthalate, polyethylene terephthalate, polyamide, acrylonitrile butadiene styrene resin and polycarbonate/acrylonitrile butadiene styrene.

8. The extruder according to claim 7, wherein the fiber-reinforce material is glass fiber or carbon fiber.
